(19) United States
(12) Patent Application Publication
(10) Pub. No.: US 2017/0214043 A1
(43) Pub. Date: Jul. 27, 2017

(54) METHOD FOR CARBON COATING ON ELECTRODE ACTIVE MATERIAL OF LITHIUM ION BATTERY

(71) Applicants: JIANGSU HUADONG INSTITUTE OF LI-ION BATTERY CO., LTD., Suzhou (CN); TSINGHUA UNIVERSITY, Beijing (CN)

(72) Inventors: Shao-Jun Liu, Suzhou (CN); Li Wang, Beijing (CN); Jian-Jun Li, Beijing (CN); Xiang-Ming He, Beijing (CN); Jing Luo, Suzhou (CN); Cheng-Hao Xu, Beijing (CN); Yu-Ming Shang, Beijing (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/482,466

(22) Filed: Apr. 7, 2017

Related U.S. Application Data
(63) Continuation of application No. PCT/CN2015/091458, filed on Oct. 8, 2015.

(30) Foreign Application Priority Data
Oct. 14, 2014 (CN) 201410538847.5

(51) Int. Cl. H01M 4/36; H01M 4/62; H01M 4/58; H01M 4/04; H01M 10/0525

(52) U.S. Cl. CPC H01M 4/366; H01M 4/0471; H01M 10/0525; H01M 4/5825; H01M 4/625

(57) ABSTRACT

A method for carbon coating on an electrode active material of a lithium ion battery is disclosed. The method comprises mixing a plurality of electrode active material particles, a carbon source, and a first solvent to obtain a first mixture liquid; heating the first mixture liquid at a temperature from about 130° C. to about 240° C. under a pressure from about 0.2 MPa to about 30 MPa to obtain a plurality of carbon source coated electrode active material particles; separating the plurality of carbon source coated electrode active material particles from the first mixture liquid; and sintering the plurality of carbon source coated electrode active material particles to obtain a plurality of carbon coated electrode active material particles.

### CROSS-REFERENCE TO RELATED APPLICATIONS

This application claims all benefits accruing under 35 U.S.C. §119 from China Patent Application No. 201410538847.5, filed on Oct. 14, 2014 in the State Intellectual Property Office of China, the content of which is hereby incorporated by reference. This application is a continuation under 35 U.S.C. §120 of international patent application PCT/CN2015/091458 filed on Oct. 8, 2015, the content of which is also hereby incorporated by reference.

### FIELD

The present disclosure relates to lithium ion batteries, especially to methods for carbon coating on electrolyte active materials of lithium ion batteries.

### BACKGROUND

Properties of a cathode active material or an anode active material can greatly affect the performance of a lithium ion battery. Therefore, research and development of electrode active materials with excellent properties are very important to the application of the lithium ion battery.

The common cathode active materials (such as layer type lithium cobalt oxide, layer type lithium nickel oxide, spinel type lithium manganese oxide, olivine type lithium iron phosphate, and modification materials thereof), and the common anode active materials (such as lithium titanate) both have low electrical conductivities. To improve the electrical conductivities, two kinds of methods including refining the electrode active materials (such as preparing nanosized electrode active materials), and carbon coating on the electrode active materials are commonly used.

Carbon coating on the nanosized electrode active materials can improve the electrical conductivities. In a common sintering method for carbon coating on the nanosized electrode active materials, before the sintering, the nanosized electrode active material particles are mixed with a carbon source by ball-milling or grinding, during which not only morphologies of the nanosized electrode active material particles are destroyed, but also the nanosized electrode active material particles are aggregated, which diminishes the advantages of the nanosized electrode active materials.

### BRIEF DESCRIPTION OF THE DRAWINGS

Implementations are described by way of example only with reference to the attached figures.

FIG. 1 is a flow chart of one embodiment of a method for coating carbon on an electrode active material of a lithium ion battery.

FIG. 2 is a graph showing charge and discharge curves of Example 1, and Comparative Examples 1 to 4 of carbon coated LiFePO₄ cathode active material particles.

### DETAILED DESCRIPTION

A detailed description with the above drawings is made to further illustrate the present disclosure.

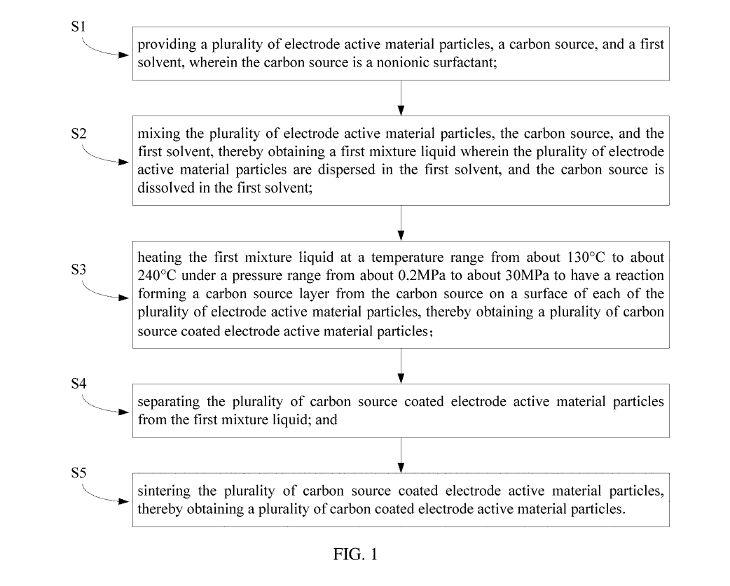

Referring to FIG. 1, one embodiment of a method for carbon coating an electrode active material of a lithium ion battery comprises the following steps of:

S1, providing a plurality of electrode active material particles, a carbon source, and a first solvent, wherein the carbon source can be a nonionic surfactant;

S2, mixing the plurality of electrode active material particles, the carbon source, and the first solvent, thereby obtaining a first mixture liquid wherein the plurality of electrode active material particles are dispersed in the first solvent, and the carbon source is dissolved in the first solvent;

S3, heating the first mixture liquid at a temperature range from about 130° C. to about 240° C. under a pressure range from about 0.2 MPa to about 30 MPa to have a reaction forming a carbon source layer from the carbon source on a surface of each of the plurality of electrode active material particles, thereby obtaining a plurality of carbon source coated electrode active material particles;

S4, separating the plurality of carbon source coated electrode active material particles from the first mixture liquid; and

S5, sintering the plurality of carbon source coated electrode active material particles, thereby obtaining a plurality of carbon coated electrode active material particles.

In S1, the electrode active material particles can be cathode active material particles, or anode active material particles. The electrode active material particles can be nanosized electrode active material particles which have excellent electrochemical properties.

The cathode active material particles can be at least one of spinel type lithium manganese oxide, layer type lithium manganese oxide, lithium nickel oxide, lithium cobalt oxide, lithium iron phosphate, lithium nickel manganese oxide, and lithium cobalt nickel manganese oxide, and the oxides can be doped with other chemical elements. The spinel type lithium manganese oxide can be represented by a chemical formula of LiₘMn₂₋ₙLₙO₄. The layer type lithium manganese oxide can be represented by a chemical formula of LiₘMn₁₋ₙLₙO₂. The lithium nickel oxide can be represented by a chemical formula of LiₘNi₁₋ₙLₙO₂. The lithium cobalt oxide can be represented by a chemical formula of LiₘCo₁₋ₙLₙO₂. The lithium iron phosphate can be represented by a chemical formula of LiₘFe₁₋ₙLₙPO₄. The lithium nickel manganese oxide can be represented by a chemical formula of LiₘNi_{0.5+z-a}Mn_{1.5-z-b}LₐR_{b}O₄. The lithium cobalt nickel manganese oxide can be represented by a chemical formula of LiₘNi_{c}Co_{d}MnₑL_{f}O₂. 0.1≦m≦1.1, 0≦n<1, 0≦z<1.5, 0≦a-z<0.5, 0<b+z<1.5, 0<c<1, 0<d<1, 0<e<1, 0≦f≦0.2, and c+d+e+f=1. L and R can be selected from at least one of alkali metal elements, alkaline earth metal elements, group 13 elements, group 14 elements, transition metal elements, and rare earth elements, such as at least one of Mn, Ni, Cr, Co, V, Ti, Al, Fe, Ga, Nd, and Mg.

The anode active material particles can be at least one of lithium titanate, titanium dioxide, and cobaltosic oxide (i.e., cobalt(II,III) oxide). The lithium titanate can be doped or non-doped lithium titanate. The doped or non-doped lithium titanate can be spinel structure. The non-doped lithium titanate can be represented by a chemical formula of Li₄Ti₅O₁₂. The doped lithium titanate can be represented by a chemical formula of Li_{(4-g)}A_{g}Ti₅O₁₂ or Li₄AₕTi₍₅₋ₕ₎O₁₂, wherein 0<g≦0.33, and 0<h≦0.5, the element A can be selected from at least one of alkali metal elements, alkaline earth metal elements, group 13 elements, group 14 elements, transition metal elements, and rare earth elements, such as at least one of Mn, Ni, Cr, Co, V, Al, Fe, Ga, Nd, Nb and Mg.

The carbon source can be at least one of polyvinyl pyrrolidone, polyethylene glycol, fatty acid ethoxylate, alkyl alcohol ethoxylate, alkyl phenol ethoxylate, fatty amine ethoxylate, alkyl amide ethoxylate, sorbitan fatty acid ester, and polyoxyethylene sorbitan fatty acid ester. In one embodiment, the carbon source can be polyvinyl pyrrolidone.

An amount of the carbon source can be determined according to a thickness of the carbon layer. A mass ratio of the carbon source to the plurality of electrode active material particles in the first mixture liquid can be in a range from about 10% to about 300%, such as from about 20% to about 200%.

The first solvent is capable of dispersing the plurality of electrode active material particles, and dissolving the carbon source. The first solvent can be selected from water, ethanol, ethylene glycol, glycerol, diethylene glycol, triethylene glycol, tetraethylene glycol, butanetriol, butanol, isobutanol, polyethylene glycol, dimethyl formamide, and combinations thereof.

In S2, the plurality of electrode active material particles, the carbon source, and the first solvent can be mixed in a variety of ways to obtain the first mixture liquid. In one embodiment, the first mixture liquid can be obtained by the following steps of:

S21, providing a dispersion liquid, wherein the dispersion liquid can comprise the first solvent and the plurality of electrode active material particles uniformly dispersed in the first solvent; and

S22, adding the carbon source to the dispersion liquid, and dissolving the carbon source into the first solvent.

Because the plurality of electrode active material particles are uniformly dispersed in the first solvent, the carbon source can be evenly distributed around each of the plurality of electrode active material particles when dissolved in the first solvent. Furthermore, as the carbon source is the nonionic surfactant, a dispersibility of the plurality of electrode active material particles in the first solvent is improved.

The dispersion liquid can be obtained in a variety of ways. In one embodiment, the dispersion liquid can be obtained by: adding and dispersing the plurality of electrode active material particles in the first solvent by stirring or ultrasonic vibration.

In another embodiment, the dispersion liquid can be obtained by the following steps of:

S211, providing an electrode active material precursors and the first solvent;

S212, carrying out a liquid phase reaction of the electrode active material precursors in the first solvent, thereby obtaining a second mixture liquid, wherein the second mixture liquid comprises the first solvent, and the plurality of electrode active material particles dispersed in the first solvent; and

S213, using the second mixture liquid as the dispersion liquid.

In S211, the electrode active material precursors can be raw materials which are essential reactants to produce the plurality of electrode active material particles by the liquid phase reaction. The electrode active material precursors can be selected according to the plurality of electrode active material particles to be prepared and the specific type of the liquid phase reaction. In one embodiment, to prepare a plurality of lithium iron phosphate cathode active material particles by a solvothermal method, the electrode active material precursors can comprise a lithium source, a ferrous source, and a phosphate radical source.

In S212, the liquid phase reaction can be selected from a hydrothermal method, a solvothermal method, a coprecipitation method, a supercritical hydrothermal method, and a microwave synthesis method, which are carried out in a liquid phase environment to prepare the plurality of electrode active material particles. A plurality of nanosized electrode active material particles can be directly produced in the first solvent during the liquid phase reaction, thereby getting excellent dispersibility and uniformity of the plurality of nanosized electrode active material particles in the second mixture.

In S213, in one embodiment, the second mixture liquid can be directly used as the dispersion liquid, thereby avoiding aggregation of the plurality of nano sized electrode active material particles.

In another embodiment, the second mixture liquid can be used as the dispersion liquid after removing impurities in the second mixture. The impurities may comprise unreacted ionic impurities which would be introduced into the plurality of carbon coated electrode active material particles if not removed. The impurities can be removed from the second mixture liquid by the following steps of:

S2131, washing the second mixture liquid using a second solvent, and obtaining wet powder by filtering but not drying, wherein the wet powder can comprise the plurality of electrode active material particles, and the second solvent adsorbed on the surface of each of the plurality of electrode active material particles;

S2132, dispersing the wet powder in the first solvent, thereby obtaining the second mixture liquid substantially without the impurities; and

S2133, using the second mixture liquid substantially without the impurities as the dispersion liquid.

In S2131, the impurities can be dissolved in the second solvent, and thus taken away by the second solvent in the process of washing. The first solvent and the second solvent can be soluble to each other at any proportion. The second solvent can be selected from water, ethanol, ethylene glycol, glycerol, diethylene glycol, triethylene glycol, tetraethylene glycol, butanetriol, butanol, isobutanol, polyethylene glycol, dimethyl formamide, and combinations thereof. The second solvent can be the same as the first solvent.

In S2132, because the second solvent is absorbed on the surface of each of the plurality of electrode active material particles, the surface energy of each of the plurality of electrode active material particles can be greatly decreased, thereby decreasing the aggregation of the plurality of electrode active material particles, and improving the dispersibility and uniformity of the plurality of electrode active material particles in the second mixture liquid.

In S3, a coordination complex of the carbon source which is the nonionic surfactant and the plurality of electrode active material particles can be formed at a temperature range from about 130° C. to about 240° C. under the pressure range from about 0.2 MPa to about 30 MPa. The carbon source can be uniformly and tightly joined to the surface of each of the plurality of electrode active material particles, thereby forming the carbon source layer on the surface of each of the plurality of electrode active material particles. Due to a steric hindrance effect of the carbon source layer, the plurality of carbon source coated electrode active material particles cannot aggregate together, and the monodispersity and uniformity of the plurality of nanosized electrode active material particles can be maintained. The carbon source layer can be converted to the continuous and uniform carbon layer on the surface of each of the plurality of electrode active material particles in S5, thereby obtaining the plurality of carbon coated electrode active material particles with excellent monodispersity, uniformity, and homogeneity.

If the first mixture liquid is heated at a temperature lower than about 130° C., the coordination complex cannot be formed by the nonionic surfactant and the plurality of electrode active material particles, and the carbon source layer cannot be obtained on the surface of each of the plurality of electrode active material particles. If the first mixture liquid is heated at a temperature higher than about 240° C., the carbon source can decompose. In one embodiment, the first mixture liquid can be heated at a temperature range from about 150° C. to about 220° C. A thickness of the carbon source layer can be increased with heating the first mixture liquid at a temperature range from about 130° C. to about 250° C. when an amount of the carbon source is given. The thickness of the carbon layer can be controlled by the thickness of the carbon source layer.

In S4, the plurality of carbon source coated electrode active material particles can be separated from the first mixture liquid by filtering or centrifugation. After separating out from the first mixture liquid, the plurality of carbon source coated electrode active material particles can be washed using water or an organic solvent, and then dried naturally, or dried by an oven drying method, a vacuum drying method, a microwave drying method, or a spray drying method.

In S5, in the process of sintering, the carbon source can be cracked into elemental carbon to form the uniform and continuous carbon layer on the surface of each of the plurality of electrode active material particles. The plurality of carbon source coated electrode active material particles can be sintered in an inert gas. A sintering temperature is not limited as long as the carbon source can be cracked into the elemental carbon. In one embodiment, the sintering temperature can be in a range from about 400° C. to about 1000° C., such as from about 600° C. to about 750° C. A sintering time can be in a range from about 2 hours to about 10 hours.

### EXAMPLE 1

80 mL of ethylene glycol and 4.19 g of lithium hydroxide monohydrate are mixed by stirring for 60 minutes, and then 1.63 ml of phosphoric acid is added to obtain a uniform white solution A. 100 mL of ethylene glycol and 8.34 g of ferrous sulfate are mixed by stirring for 60 minutes to obtain a uniform mixture solution B. The mixture solution B is added into the white solution A drop by drop, stirred for 30 minutes, sealed into a solvothermal reactor having a polytetrafluoroethylene lining, and heated at 180° C. for 10 hours to obtain a mixture liquid wherein a plurality of LiFePO₄ cathode active material particles are uniformly dispersed in the ethylene glycol.

Polyvinyl pyrrolidone is added, and dissolved into the mixture liquid by stirring for 0.5 hour to 2 hours, and then sealed into a high pressure reactor, and heated at 180° C. under 0.4 MPa for 4 hours to obtain a plurality of polyvinyl pyrrolidone coated LiFePO₄ cathode active material particles. The mass of the polyvinyl pyrrolidone is 100% of the mass of the plurality of LiFePO₄ cathode active material particles. The plurality of polyvinyl pyrrolidone coated LiFePO₄ cathode active material particles are washed using water and anhydrous alcohol, centrifugal separated, vacuum dried at 80° C., and sintered at 650° C. in a nitrogen gas for 5 hours to obtain a plurality of carbon coated LiFePO₄ cathode active material particles.

### COMPARATIVE EXAMPLE 1

The method in Comparative Example 1 is substantially the same as the method in Example 1, except that the carbon source is glucose.

### COMPARATIVE EXAMPLE 2

The method in Comparative Example 2 is substantially the same as the method in Example 1, except that the carbon source is sucrose.

### COMPARATIVE EXAMPLE 3

The method in Comparative Example 3 is substantially the same as the method in Example 1, except that the carbon source is ionic surfactant cetyltrimethyl ammonium bromide (CTAB).

### COMPARATIVE EXAMPLE 4

The method in Comparative Example 4 is substantially the same as the method in Example 1, except that after obtaining the mixture liquid, the mixture liquid is washed using water and anhydrous alcohol, centrifugal separated, vacuum dried at 80° C. to obtain a dry powder of the LiFePO₄ cathode active material. The dry powder of the LiFePO₄ cathode active material is mixed with polyvinyl pyrrolidone by ball-milling with alcohol as a dispersant, and sintered at 650° C. in a nitrogen gas for 5 hours to obtain a plurality of carbon coated LiFePO₄ cathode active material particles.

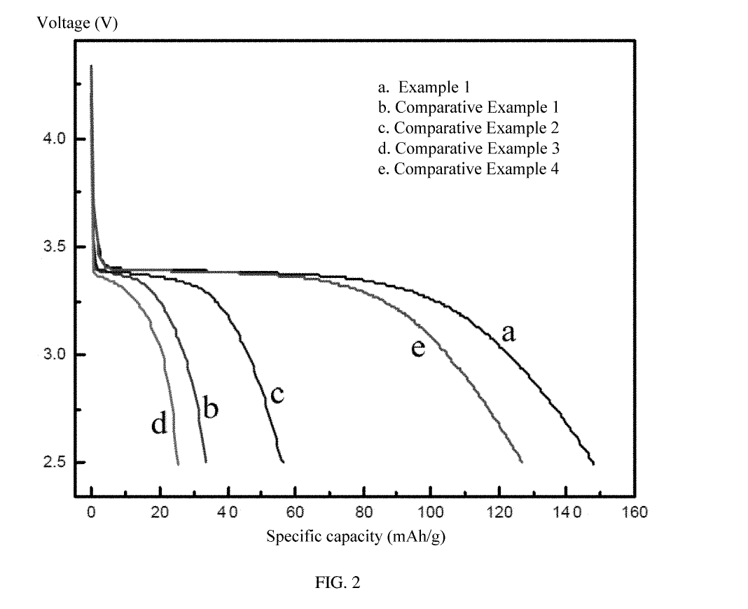

FIG. 2 is a graph showing charge and discharge curves of Example 1, and Comparative Examples 1 to 4 of the carbon coated LiFePO₄ cathode active material particles at a charge and discharge rate of 0.2 C. It can be seen from FIG. 2 that at the charge and discharge rate of 0.2 C, a specific capacity of the carbon coated LiFePO₄ cathode active material particles with polyvinyl pyrrolidone as carbon source is 147.9 mAh/g, a specific capacity of the carbon coated LiFePO₄ cathode active material particles with glucose as carbon source is 33.7 mAh/g, a specific capacity of the carbon coated LiFePO₄ cathode active material particles with sucrose as carbon source is 56.2 mAh/g, a specific capacity of the carbon coated LiFePO₄ cathode active material particles with CTAB as carbon source is 25.3 mAh/g, and a specific capacity of the carbon coated LiFePO₄ cathode active material particles obtained by the common carbon coating method with polyvinyl pyrrolidone as carbon source is 127 mAh/g. The carbon coated LiFePO₄ cathode active material particles obtained by the present disclosure carbon coating method with nonionic surfactant as carbon source has more excellent electrochemical performance.

In the present disclosure, a plurality of electrode active material particles are dispersed in a first solvent, and a carbon source is dissolved in the first solvent and evenly distributed around each of the plurality of electrode active material particles. A coordination complex of the carbon source which is a nonionic surfactant and the plurality of electrode active material particles can be formed at a temperature range from about 130° C. to about 240° C. under a pressure range from about 0.2 MPa to about 30 MPa, thereby forming a carbon source layer on a surface of each of the plurality of electrode active material particles. Due to the steric hindrance effect of the carbon source layer, the plurality of carbon source coated electrode active material particles cannot aggregate together. The carbon source layer is transformed to a continuous and uniform carbon layer by sintering the coordination complex, thereby obtaining a plurality of carbon coated electrode active material particles with good monodispersity, uniformity, excellent electrical conductivity, and improved electrochemical performance.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for carbon coating an electrode active material of a lithium ion battery, comprising:
providing a plurality of electrode active material particles, a carbon source, and a first solvent, wherein the carbon source is a nonionic surfactant;
mixing the plurality of electrode active material particles, the carbon source, and the first solvent, thereby obtaining a first mixture liquid wherein the plurality of electrode active material particles are dispersed in the first solvent, and the carbon source is dissolved in the first solvent;
heating the first mixture liquid at a temperature from about 130° C. to about 240° C. under a pressure from about 0.2 MPa to about 30 MPa to have a reaction forming a carbon source layer from the carbon source on a surface of each of the plurality of electrode active material particles, thereby obtaining a plurality of carbon source coated electrode active material particles;
separating the plurality of carbon source coated electrode active material particles from the first mixture liquid; and
sintering the plurality of carbon source coated electrode active material particles, thereby obtaining a plurality of carbon coated electrode active material particles.

2. The method of claim 1, wherein the first mixture liquid is obtained by:
providing a dispersion liquid, wherein the dispersion liquid comprises the first solvent, and the plurality of electrode active material particles uniformly dispersed in the first solvent; and
adding the carbon source to the dispersion liquid, and dissolving the carbon source into the first solvent.

3. The method of claim 2, wherein the dispersion liquid is obtained by:
providing electrode active material precursors, and the first solvent;
carrying out a liquid phase reaction of the electrode active material precursors in the first solvent, thereby obtaining a second mixture liquid, wherein the second mixture liquid comprises the first solvent, and the plurality of electrode active material particles dispersed in the first solvent; and
using the second mixture liquid as the dispersion liquid.

4. The method of claim 3, wherein the liquid phase reaction is selected from a hydrothermal method, a solvothermal method, a coprecipitation method, a supercritical hydrothermal method, and a microwave synthesis method.

5. The method of claim 3, wherein the second mixture liquid is directly used as the dispersion liquid.

6. The method of claim 3, wherein the second mixture liquid is used as the dispersion liquid after removing impurities in the second mixture.

7. The method of claim 6, wherein the impurities are removed from the second mixture liquid by:
washing the second mixture liquid using a second solvent, and obtaining wet powder by filtering but not drying, wherein the wet powder can comprise the plurality of electrode active material particles, and the second solvent adsorbed on the surface of each of the plurality of electrode active material particles;
dispersing the wet powder in the first solvent, thereby obtaining the second mixture liquid substantially without the impurities; and
using the second mixture liquid substantially without the impurities as the dispersion liquid.

8. The method of claim 7, wherein the first solvent and the second solvent are soluble to each other at any proportion.

9. The method of claim 1, wherein the carbon source is selected from the group consisting of polyvinyl pyrrolidone, polyethylene glycol, fatty acid ethoxylate, alkyl alcohol ethoxylate, alkyl phenol ethoxylate, fatty amine ethoxylate, alkyl amide ethoxylate, sorbitan fatty acid ester, and polyoxyethylene sorbitan fatty acid ester, and combinations thereof.

10. The method of claim 1, wherein the carbon source is polyvinyl pyrrolidone.

11. The method of claim 1, wherein a mass ratio of the carbon source to the plurality of electrode active material particles in the first mixture liquid is in a range from about 10% to about 300%.

12. The method of claim 1, wherein a mass ratio of the carbon source to the plurality of electrode active material particles in the first mixture liquid is in a range from about 20% to about 200%.

13. The method of claim 1, wherein the first solvent is selected from the group consisting of water, ethanol, ethylene glycol, glycerol, diethylene glycol, triethylene glycol, tetraethylene glycol, butanetriol, butanol, isobutanol, polyethylene glycol, dimethyl formamide, and combinations thereof.

14. The method of claim 1, wherein the plurality of electrode active material particles is a plurality of nanosized electrode active material particles.

15. The method of claim 1, wherein the plurality of carbon source coated electrode active material particles are sintered at a temperature from about 400° C. to about 1000° C. in an inert gas.

16. The method of claim 1, wherein the first mixture liquid is heated at a temperature from about 150° C. to about 220° C. under the pressure from about 0.2 MPa to about 30 MPa to form the carbon source layer.
